(19) United States
(12) Patent Application Publication
(10) Pub. No.: US 2007/0119867 A1
(43) Pub. Date: May 31, 2007

(54) Chilled drink preparation control device

(75) Inventors: Yutaka Nakato, Mie (JP); Noriyuki Kobayashi, Mie (JP)

Correspondence Address: Reed Smith, 3110 Fairview Park Drive, Suite 1400, Falls Church, VA, 22042, US

(73) Assignee: JOYTEC CORPORATION, Mie (JP)

(21) Appl. No.: 10/566,608

(22) PCT Filed: Jul. 31, 2003
(86) PCT No.: PCT/JP03/09716

§ 371 Date: Nov. 21, 2006

(51) Int. Cl. G01F 13/00

(52) U.S. Cl. 222/222

(57) ABSTRACT

A microcomputer (160) is programmed to determine an amount of ice cubes to be sliced on a basis of operation of either one of size button switches (80a˜80c), to determine a mixing time for mixing sliced ice with an amount of beverage on a basis of operation of either one of drink button switches (90a˜90c) and to control each operation of a shaving motor (M1) and a mixing motor (M2) for preparation of an amount of cold beverage.

### FIELD OF THE INVENTION

The present invention relates to a control apparatus of a cold beverage blender.

### DESCRIPTION OF THE PRIOR ART

Disclosed in Japanese Patent Laid-open Publication NO 63-222655 is a soft ice beverage blender of the type which includes an ice cutting mechanism for slicing ice cubes to produce an amount of sliced ice and a mixing mechanism for mixing the sliced ice with an amount of beverage stored in a container to provide soft ice beverage. In the soft ice beverage blender, a cutting time of ice cubes in the ice cutting mechanism is adjusted by a timer in an electric control circuit. Accordingly, the amount of sliced ice formed in the ice cutting mechanism is determined by adjustment of the cutting time. For this reason, it is difficult to adjust the amount of sliced ice in accordance with user's taste. Even if the setting time of the timer in the electric control circuit was adjusted in accordance with user's taste, such adjustment of the timer would not be realistic in use of the soft ice beverage blender.

### SUMMARY OF THE INVENTION

It is, therefore, a primary object of the present invention to provide a control apparatus for a cold beverage blender capable of adjusting an amount of sliced ice in accordance with user's taste in a simple manner.

According to the present invention, the object is accomplished by providing an electric control apparatus for a cold beverage blender which comprises an ice cutting mechanism (SM) with a shaving motor (M1) operated for slicing ice cubes, a mixing mechanism (60) with a mixing motor (M2) operated for mixing sliced ice with beverage stored in a container to prepare an amount of cold beverage, means (80a-80c, 80) for setting an amount of ice cubes sliced in the cutting mechanism to a desired amount, means (90a- 90c) for setting the number (N) of cups of cold beverage desired by a user, control means (170a, 390, 391, 440-461, 480-521) for controlling operation of the shaving motor in accordance with the set amount of ice cubes and the number of cups of cold beverage, and control means (170b, 364) for controlling operation of the mixing motor in accordance with the set amount of ice cubes and the number of cups of cold beverage.

In the control apparatus of the cold beverage blender, an amount of ice cubes to be sliced in the cutting mechanism is set in accordance with the number of cups of cold beverage for preparation of cold beverage suitable to user's taste. Thus, the setting means for the amount of sliced ice is useful for a user to adjust the amount of sliced ice to a desired amount. As the shaving and mixing motors are operated under control of the control means, an amount of cold beverage is prepared for the number of cups set by the user.

In the case that the control apparatus of the present invention is provided with means for setting viscosity of beverage, it is preferable that the control means of the mixing motor is arranged to decrease or increase operation time of the mixing means in accordance with the viscosity of beverage set by the setting means. With such arrangement of the control means, the mixing of beverage with sliced ice is effected in a good condition.

In the case that the means for setting an amount of ice cubes to be sliced is in the form of a plurality of switches (80a-80c) operated by a user for setting a different amount of ice cubes and that the shaving motor control means is arranged to control operation of the shaving motor in such a manner that a desired amount of ice cubes set by operation of either one of the switches is sliced in the cutting mechanism, the useful effects described above are attainable.

In the case that the means for setting a desired amount of ice cubes to be sliced is in the form of an analog setting device (80) for setting a desired amount of ice cubes in an analog amount and that the shaving motor control means is arranged to control operation of the shaving motor in such a manner that a desired amount of ice cubes set by operation of the analog setting device is sliced in the cutting mechanism, a desired amount of sliced ice can be finely determined by the user.

In the case that the viscosity setting means is in the form of a plurality of manual switches (100a, 100b) for setting a different viscosity in accordance with viscosity of the beverage and that the mixing motor control means is arranged to activate the mixing motor for a mixing time determined in accordance with the viscosity set by operation of either one of the manual switches, the useful effects can be attainable by operation of the manual switches.

In the case that the viscosity setting means is in the form of an analog setting device (100) for setting a viscosity in an analog amount in accordance with viscosity of the beverage and that the mixing motor control means is arranged to activate the mixing motor for a mixing time determined in accordance with the analog amount of viscosity set by operation of the analog setting device, the viscosity of cold beverage can be analogously defined, and the useful effects can be finely attainable.

### BRIEF DESCRIPTION OF THE DRAWINGS

In the drawings:

FIG. 1 is a sectional view of a cold beverage blender which is operated under control of an electric control apparatus in accordance with the present invention;

FIG. 2 is a perspective view of the cold beverage blender shown in FIG. 1;

FIG. 3 is a block diagram of an electric circuit of the control apparatus;

FIG. 4 is a perspective view of a rectifier mounted on the bottom of a cutting disk in the beverage blender;

FIG. 5 illustrates a thrust force acting on ice cubes in a cutting mechanism of the beverage blender;

FIG. 6 is a front view of an operation panel shown in FIG. 2;

FIGS. 7 to 11 illustrate a flow chart of a control program executed by a microcomputer shown in FIG. 3;

FIG. 12 is a timing chart illustrating each operation of a shaving motor and a mixing motor activated in accordance with the number N of cups of beverage;

FIG. 13 is a front view of another embodiment of the operation panel;

FIG. 14 is a graph showing a mixing time in relation to viscosity of beverage; and

FIG. 15 is a front view of a modification of the operation panel.

### DESCRIPTION OF PREFERRED EMBODIMENTS

Hereinafter, preferred embodiments of the present invention will be described with reference to the drawings.

### First Embodiment

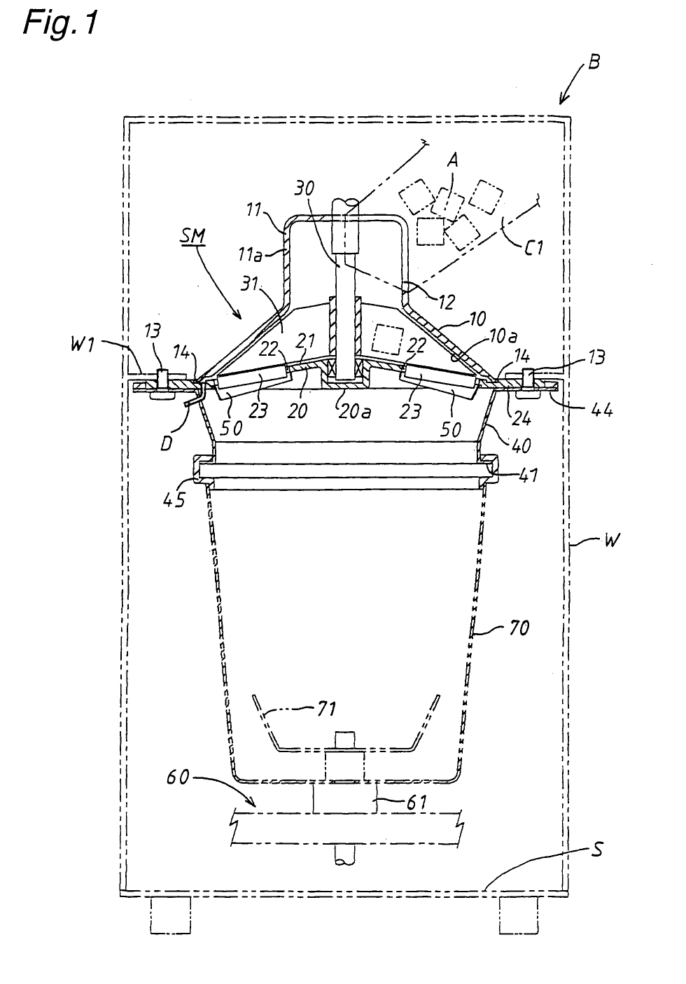

Illustrated in FIGS. 1-3 is a first embodiment of an electric control apparatus E of a cold beverage blender B in accordance with the present invention. As shown in FIG. 1, the cold beverage blender B is provided with an ice cutting mechanism SM which includes an upright machine frame W mounted on a base structure S, an upper hood 10 horizontally mounted within the upright frame W to be removable downwardly, and a cutting disk 20 coupled at its lower end periphery with the lower end outer periphery of upper hood 10 to be removable downwardly. The ice cutting mechanism SM further includes a rotary shaft 30 extended through the center of upper hood 10 and supported at its lower end on a boss portion formed on the head of cutting disk 20, and rotary plates 31 driven by rotation of the rotary shaft 30 to rotate along the upper surface of cutting disk 20.

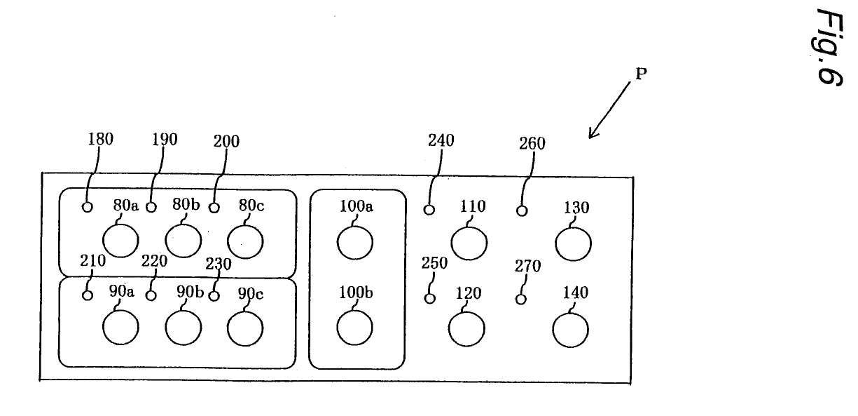

The upper hood 10 has a downwardly inclined conical inner surface 10a and a cylindrical head portion 11 formed at its peripheral wall 11a with an inlet opening 12 through which a chute C1 is inserted from upward to introduce ice cubes falling from an ice storage container C placed above the machine frame W. The cutting disk 20 has a downwardly inclined conical upper surface 21. A pair of cutting blades 23 are mounted on the cutting disk in such a manner that the edges of the cutting blades are positioned upward at a pair of radial slits formed in the upper surface 21 of cutting disk 20. In this embodiment, the inclined angle θ1 of the conical upper surface is determined at 10° staking into account of the size of ice cubes supplied from the ice storage container 40, while the inclined angle θ2 of the conical inner surface of upper hood 10 is determined at 50° (see FIG. 5) Such arrangement of the angles is effective to increase the component of a centrifugal force F acting on the ice cubes A caused by rotation of the rotary plates 31 (or a thrust force acting on the cutting blades 23 of ice cubes) in cutting operation.

The three rotary plates 31 are circumferentially equally spaced and mounted to the rotary shaft 30 for rotation along the conical upper surface 21 of cutting disk 20 in a condition where the bottoms of rotary plates 31 are spaced in a predetermined gap from the edges of cutting blades 23. In this embodiment, an electric shaving motor M1 is mounted on an upper portion of the machine frame at one side of the upper hood 10 to drive the rotary shaft 30 by way of a belt-transmission mechanism.

In addition, the cutting disk 20 is formed at its lower end outer periphery with circumferentially spaced flanges 24 which are coupled with circumferentially spaced flanges 14 formed on the lower end outer periphery of upper hood 10. The flanges 24 of cutting disk 20 are fixed to a support member W1 mounted on an upper portion of the inner wall of machine frame W together with circumferentially spaced flanges 44 formed on an upper end outer periphery of a lower hood 40 by means of screws 13.

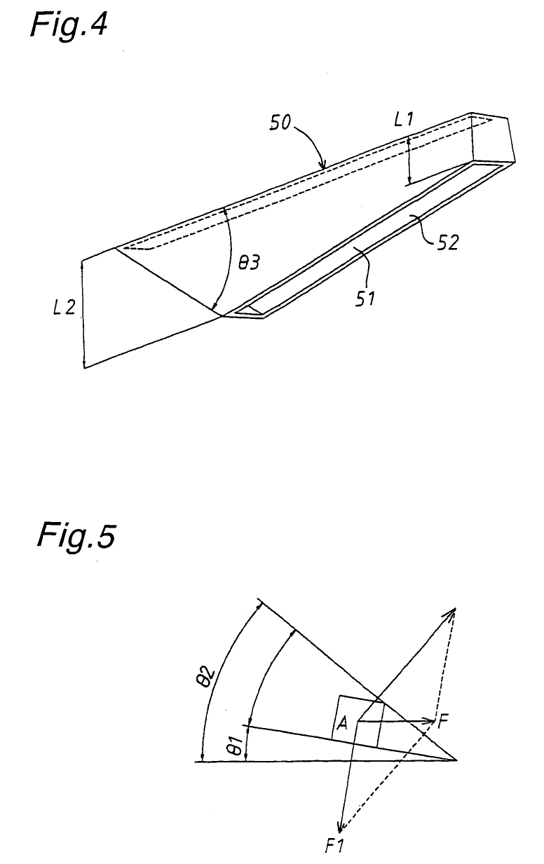

Mounted to the bottom of cutting disk 20 are rectifiers 50 which are formed respectively with a rectifying opening 51 for introducing ice pieces sliced by the cutting blade 23 toward the central portion of lower hood 40. As shown in FIG. 4, the width and length of a rectifying opening formed between the upper ends of both side walls 52 correspond with the length of cutting blades 23. The height L1 of the front ends of both side walls is determined lower than that of the rear ends thereof so that the rectifying opening 51 is formed shallow at its front end portion and deep at its rear end portion. Thus, the rear end wall of rectifying opening 51 is inclined at an angle θ3 relative to the bottom of each slit 22. (see FIG. 4) Mounted to the outer periphery of cutting disk 20 is a drain pipe D the distal end of which is extended outward from the lower hood 40.

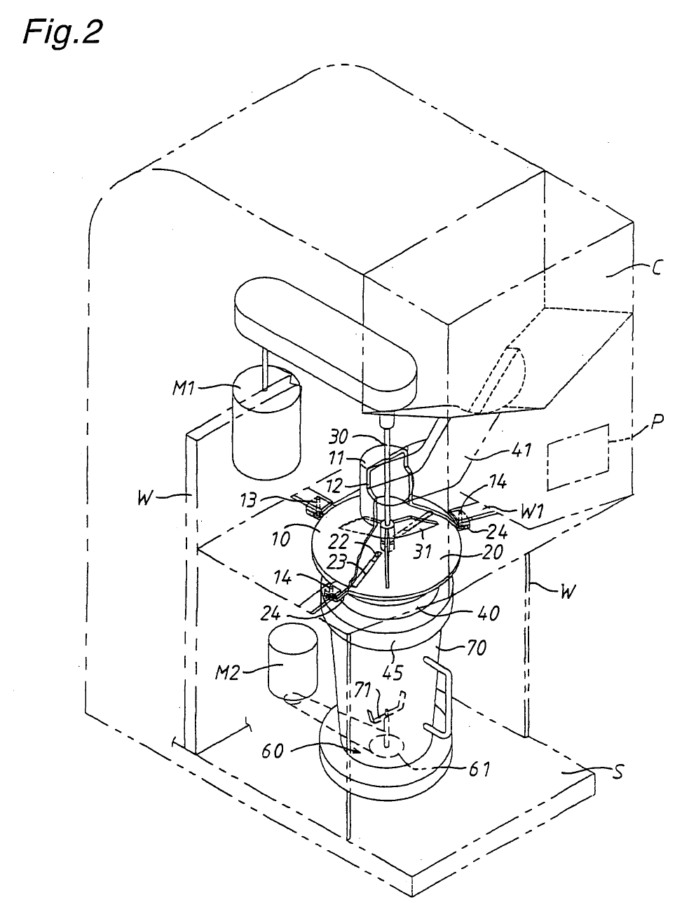

The lower hood 40 is in the form of a cylindrical member which is made of stainless steel and provided with an elastic ring 45 of silicon rubber vertically movably coupled with an annular flange 41 formed on the lower end thereof. The elastic ring 45 is coupled with the upper end opening of a beverage container 70 in a liquid-tight manner. The beverage container 70 is detachably mounted on a clutch 61 of a mixing mechanism 60 assembled on the base structure S. An agitator 71 detachably coupled with the bottom of beverage container 70 is driven by rotation of a drive shaft when the beverage container 70 has been put on the clutch 61 of the mixing mechanism for engagement therewith. As shown in FIG. 2, the input member of clutch 61 is driven by an electric mixing motor M2 mounted on the base structure S at one side of the beverage container 60. The drive shaft rotated by engagement of the clutch 51 is arranged in coaxial with the rotary shaft 30 of the rotary plates 31.

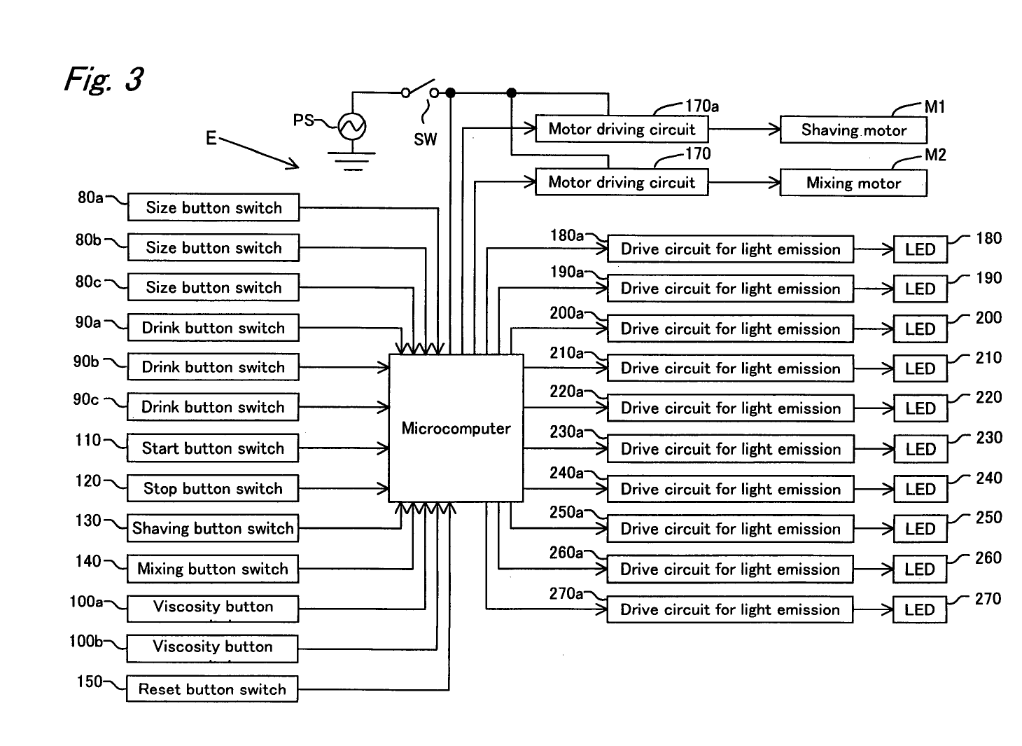

As shown in FIG. 3, an electric control apparatus E of the beverage blender is provided with three size button switches 80a˜80c, three drink button switches 90a˜90c, two viscosity button switches 100a, 100b, a start button switch 110, a stop button switch 120, a shaving button switch 130, a mixing button switch 140 and a reset button switch 150. These button switches each are in the from of a normally open switch and mounted on an operation panel P of the beverage blender. (see FIG. 2) The operation panel P is mounted on the outer face of ice storage container C.

The size button switches 80a˜80c are operated by a user when it is desired to slice ice cubes A. The size button switch 80b is operated to adjust the slice amount of ice cubes in a medium amount. The size button switch 80a is operated to adjust the slice amount of ice cubes in a smaller amount than the medium amount. The size button switch 80c is operated to adjust the slice amount of ice cubes larger than the medium amount. The drink button switch 90a is operated to prepare one cup of cold beverage, the drink button switch 90b is operated to prepare two cups of cold beverage, and the drink button switch 90c is operated to prepare three cups of cold beverage.

The viscosity button switches 100a, 100b are provided to adjust the viscosity of condensed fruit juice to be mixed with sliced ice pieces. The button switch 100a is operated when the viscosity of condensed fruit juice is low, and the button switch 100b is operated when the viscosity of condensed fruit juice is high. The start button switch 110 is operated to activate the shaving motor M1 and mixing motor M2. The stop button switch 120 is operated to deactivate the shaving motor M1 and mixing motor M2. The shaving button switch 130 is operated to compensate for shortage of the amount of sliced ice pieces after preparation of cold beverage. The mixing button switch 140 is operated to compensate for shortage of the mixed degree of condensed fruit juice after preparation of cold beverage. The reset button switch 150 is temporarily operated to deactivate the motors M1 and M2.

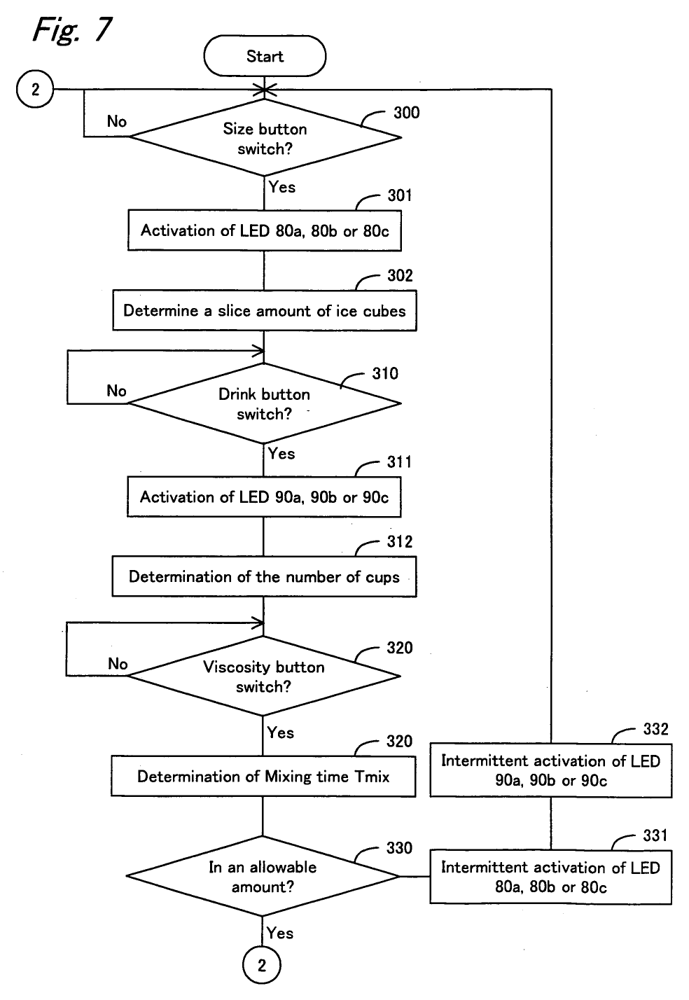

When applied with the alternating current voltage from a commercial power source PS through a source switch SW of the normally open type, a microcomputer 160 executes a control program shown by a flow chart in FIGS. 7˜11. During execution of the control program, the computer 160 acts in response to selective operation of the button switches to control operation of the motors M1, M2 through driving circuits 170a, 170b and to control activation of light emitting diodes 180˜270 (hereinafter called LED 180˜270) through driving circuits 180a˜270a for various processing required for preparation of cold beverage. The microcomputer 160 converts the alternating current voltage to a constant voltage of direct current and is activated under the constant voltage of direct current. The control program is preliminarily stored in a ROM of computer 160 in a readable manner.

The driving circuit 170a is applied with the alternating current voltage from the commercial power source PS through the power switch SW under control of the computer 160 to activate the electric shaving motor M1. Similarly, the driving circuit 170b is applied with the alternating current voltage from the commercial power source PS through the power switch SW under control of the computer 160 to activate the electric mixing motor M2.

As shown in FIG. 6, the LED 180, 190 and 200 are mounted on the operation panel P at each position near the size button switches 80a, 80b, 80c to be lighted for visual indication when operated. The LED 210, 220 and 230 are mounted on the operation panel P at each position near the drink button switches 90a, 90b, 90c to be lighted for visual indication when operated. The LED 240, 250, 260 and 270 are mounted on the operation panel P at each position near the button switches 110, 120, 130 and 140 to be lighted for visual indication when operated.

In use of the cold beverage blender, an amount of beverage such as condensed fruit juice is poured in the beverage container 70 in condition where ice cubes produced in an ice maker have been stored in the ice storage container. The beverage container 70 is put on the clutch 61 on the base structure S for engagement therewith in such a manner that the elastic ring 45 is lifted by the upper end of container 70 and coupled therewith. When the power switch SW has been turned on in such a condition, the computer 160 starts to execute the control program as in the flow chart shown in FIG. 7˜11 and determines at step 300 whether either one of the size button switches 80a˜80c has been turned on or not. If a medium amount Me of sliced ice pieces is desired, the size button switch 80b is operated by a user. If a small amount S of sliced ice pieces is desired by a woman, the size button switch 80a is operated. If a large amount L of sliced ice pieces is desired by a man, the size button switch 80c is operated.

When determined a “Yes” answer at step 300, the computer 160 executes at step 301 processing for activating either one of the LED 80a ˜80c corresponding with one of the size button switches operated by the user. Thus, one of the LED 80a˜80c is lighted by activation of the driving circuit for light emission so that the operated condition of the size button switch can be visually recognized by the user. After processing at step 301, the computer 160 determines at step 302 the amount of sliced ice pieces defined by selective operation of the size button switches. Accordingly, the small amount S of sliced ice pieces is determined by operation of the size button switch 80a, and the medium amount Me of sliced ice pieces is determined by operation of the size button switch 80b. Similarly, the large amount L of sliced ice pieces is determined by operation of the size button switch 80c.

Successively, the computer 160 determines at step 310 whether either one of the drink button switches 90a˜90c has been turned on or not. When it is desired to prepare one cup of cold beverage, the drink button switch 90a is operated by the user. If it is desired to prepare two cups of cold beverage, the drink button switch 90b is operated by the user. If it is desired to prepare three cups of cold beverage, the drink button switch 90c is operated by the user. When determined a “Yes” answer at step 310, the computer 160 executes at step 311 processing for activating either one of the LED corresponding with one of the drink button switches operated by the user. Thus, one of the LED is lighted by activation of the driving circuit for light emission so that the operated condition of the drink button switch can be visually recognized by the user. After processing at step 311, the computer 160 determines at step 312 the number of cups of cold beverage desired by the user. Accordingly, one cup of cold beverage is determined by operation of the drink button switch 90a, two cups of cold beverage are determined by operation of the drink button switch 90b, and three cups of cold beverage are determined by operation of the drink button switch 90c.

Subsequently, the computer 160 determines at step 320 whether either one of the viscosity button switches 100a and 100b has been turned on by the user or not. If the viscosity of beverage in container 70 is low, the viscosity button switch 100a is operated. If the viscosity of beverage is high, the viscosity button switch 100b is operated. When determined a “Yes” answer at step 320, the computer 160 executes at step 321 processing for determination of a mixing time Tmix of the beverage. The mixing time Tmix represents a continual driving time of the electric mixing motor M2 and is determined taking into account the amount of sliced ice, the number of cups N−1 and the viscosity of beverage as follows. When the medium amount Me of sliced ice is mixed with beverage of low viscosity, the mixing time Tmix is determined, for example, for 10 minutes. When the small amount S of sliced ice is mixed with the beverage, the mixing time Tmix is determined to be shorter than 10 minutes. When the large amount L of sliced ice is mixed with the beverage, the mixing time Tmix is determined to be longer than 10 minutes. When the medium amount Me of sliced ice is mixed with beverage of high viscosity, the mixing time Tmix is determined for 20 minutes. When the small amount S of sliced ice is mixed with the beverage of high viscosity, the mixing time Tmix is determined shorter than 20 minutes. When the large amount L of sliced ice pieces is mixed with the beverage of high viscosity, the mixing time Tmix is determined to be longer than 20 minutes. As described above, one cup of beverage is defined as a standard volume for determination of the mixing time Tmix. When the sliced ice is mixed with two or three cups of beverage, the mixing time Tmix is determined to be two or three times.

When the mixing time Tmix is determined by processing at step 321, the computer determines at step 330 whether an amount of beverage mixed with sliced ice is in an allowable amount or not. In this instance, the amount of beverage is defined in accordance with the amount of sliced ice and the number N of cups of beverage respectively specified by operation of the size button switches and the drink button switches. If the amount of beverage is not in the allowable amount, the computer determines a “No” answer at step 330 and executes processing at step 331 and 332 for intermittent activation of the LED 80a, 80b or 80c and the LED 90a, 90b or 90c. With the processing at step 331, and 332, the LED 80a, 80b or 80c and the LED 90a, 90b or 90c are intermittently lighted by activation of the driving circuit for light emission corresponding therewith under control of the computer so as to visually indicate the fact that the amount of sliced ice is not in the allowable amount.

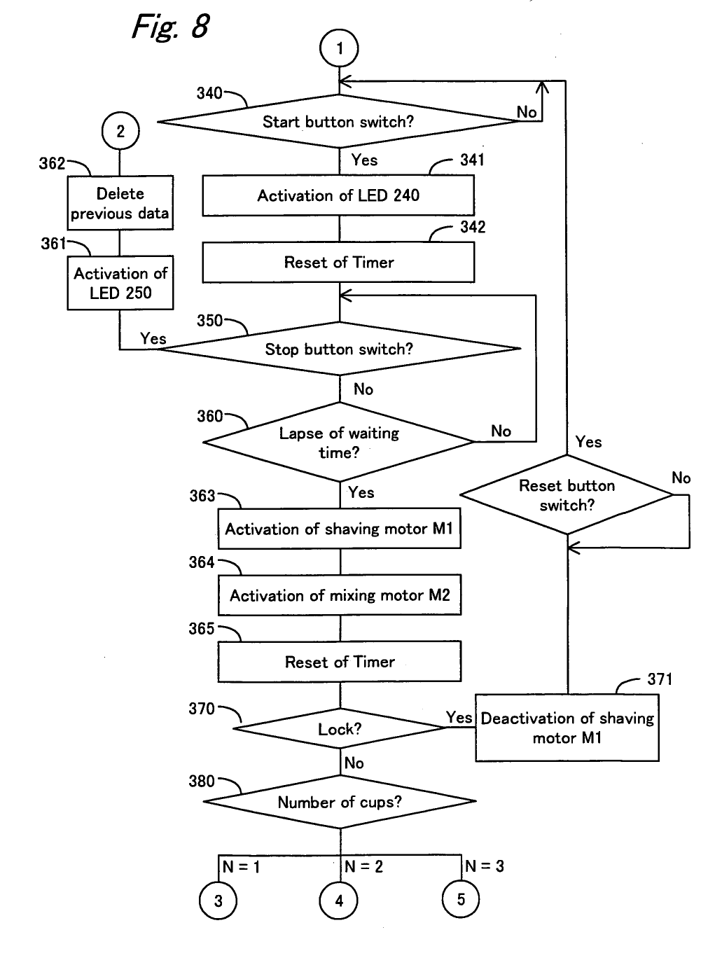

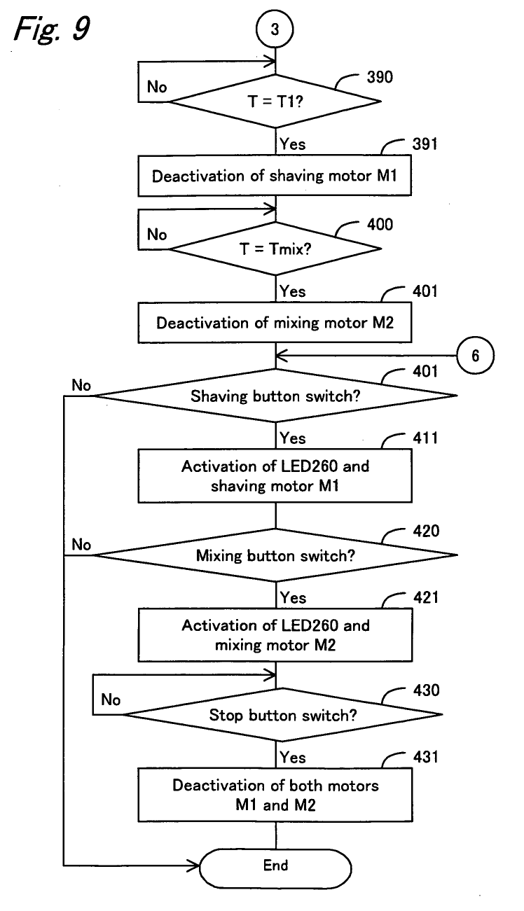

When the answer at step 330 is “Yes”, the computer determines at step 340 in FIG. 8 whether the start button switch 240 has been turned on or not. If the answer at step 340 is “Yes”, the computer executes processing at step 341 for activating the driving circuit 240a for light emission of the LED 240. With the processing at step 341, the LED 240 is lighted to visually indicate the operated condition of start button switch 240. After processing at step 340, the computer causes a timer housed therein to reset and start for measurement of a time at step 342.

Successively, the computer determines at step 350 whether the stop button switch 120 has been turned on or not. If the answer at step 350 is “No”, the computer determines at step 360 lapse of a predetermined waiting time measured by the timer. The waiting time is determined to avoid an error in setting the amount of beverage. During lapse of the waiting time, the computer determines a “No” answer at step 360 and determines at step 350 whether the stop button switch 120 has been turned on or not. If there is an error in setting the amount of beverage, the stop button switch 120 is turned on by the user. In such an instance, the computer determines a “Yes” answer at step 350 and executes processing at step 361 for activating the driving circuit 250a of the LED 250. With the processing at step 361, the LED 250 is lighted to visually indicate the fact that the stop button switch 120 was turned on due to an error in the set amount of beverage. After processing at step 361, the computer deletes the data previously set at step 300˜330 and repeats the processing at step 300˜321. When determined a “Yes” answer at step 360 upon lapse of the waiting time, the computer executes processing at step 363 for activating the driving circuit 170a of electric saving motor M1 and processing at step 364 for activating the driving circuit 170b of electric mixing motor M2.

With the processing at step 363 and 364, the electric shaving motor M1 and mixing motor M2 are activated to rotate the rotary plates 31 and agitator 71. Then, ice cubes A falling into the inlet opening 12 of upper hood 10 through the chute C1 are stirred by rotation of the rotary plates 13, moved by a centrifugal force F acting thereon toward the outer periphery of cutting disk 20, and thrusted to the conical inner surface of upper hood 10. Thus, the ice cubes are thrusted by a component F1 of the centrifugal force toward the edges of cutting blades 23 and sliced by the cutting blades 23. The sliced ice pieces are discharged from the slits 22 into the central portion of beverage container 70 through the rectifiers 50. In such an instance, the rectifiers 50 are useful to prevent the sliced ice from flying across the slits 22 and to restrict the discharging direction of sliced ice. On the other hand, the beverage stored in the container 70 is stirred with the sliced ice introduced by the rectifiers 50 during rotation of the agitator 7a and prepared as an amount of desired frozen cold beverage. In such operation, the elastic ring 45 is useful to prevent the prepared frozen cold beverage from flowing out the upper end opening of the container 70.

After the processing at step 364, the computer resets the timer at step 365 to measure lapse of a time and determines at step 370 whether the electric shaving motor M1 is locked or not. If the answer at step 370 is “Yes”, the computer executes at step 371 processing for stopping the electric shaving motor M1. When the reset button switch 150 is temporarily turned on after the processing at step 371 to reset the start button switch 110 , the computer determines a “Yes” answer at step 372 and executes the processing at step 340. If the answer at step 370 is “No”, the computer determines the number N of cups. When the number N of cups is “1”, the computer causes the program to proceed to step 390 from step 380. While lapse of a time T measured by the timer is less than a predetermined period of time T1 (for instance, 5 minutes), the computer determines a “No” answer at step 390. During lapse of the time, the electric shaving motor M1 is continually driven so that the ice cubes are continually sliced by the cutting blades 23.

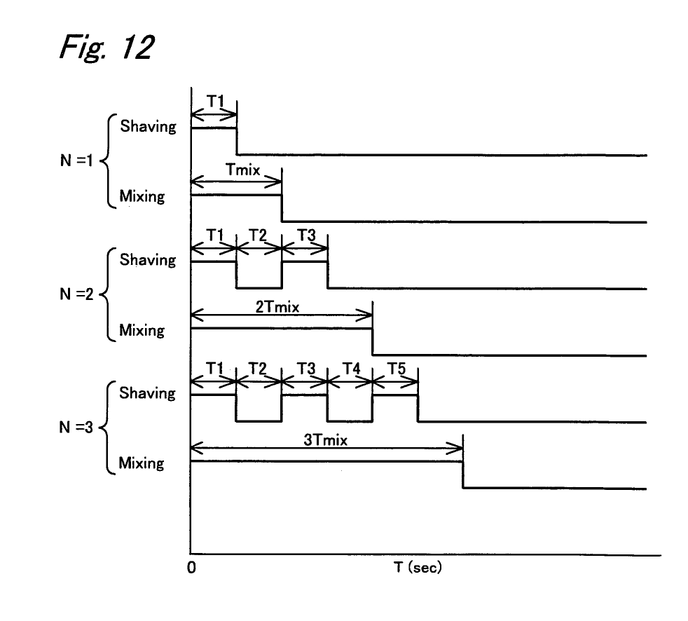

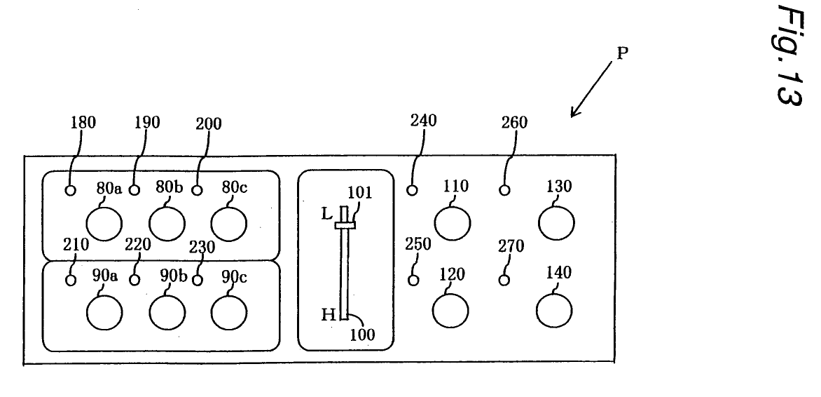

When determined a “Yes” answer at step 390, the computer executes processing for deactivating the electric shaving motor M1 at step 391. After the processing at step 391, the computer determines whether lapse of the time T measured by the timer is a predetermined mixing time Tmix or not. In this embodiment, the mixing time Tmix is determined for ten or twenty minutes. While lapse of the time T is less than the mixing time Tmix, the computer determines a “No” answer at step 400. During lapse of the time T, the electric mixing motor M2 is continually driven so that the beverage is stirred by the agitator 71 and mixed with the sliced ice pieces. (see FIG. 12) When determined a “Yes” answer at step 400, the computer executes processing for deactivating the electric mixing motor M2 at step 401. Thus, a cup of frozen cold beverage is prepared by the beverage mixed with the sliced ice.

In the case that the medium amount Me of sliced ice pieces is mixed with a cup of low viscosity beverage, the mixing time Tmix is adjusted to ten minutes for preparation of the cold beverage. When the medium amount Me of sliced ice pieces is mixed with a cup of high viscosity beverage, the mixing time Tmix is adjusted to twenty minutes for preparation of the cold beverage. When a small amount S of sliced ice pieces or a large amount L of sliced ice pieces is mixed with the beverage, the mixing time Tmix is adjusted in accordance with the amount of sliced ice pieces. With such adjustment of the mixing time Tmix, the cold beverage can be prepared in a desired condition. In addition, the amount of sliced ice pieces can be adjusted to a desired amount by selective operation of the size button switches 80a˜80c.

After the processing at step 401, the computer determines at step 410 whether the shaving button switch 130 is turned on or not. If the answer at step 401 is “Yes”, the computer executes processing for activating the LED 260 and the electric shaving motor M1 at step 411. This activates the driving circuit 260a for light emission for lighting the LED 260 and causes the driving circuit 170a to activate the electric shaving motor M1. Thus, the ice cubes are further sliced by rotation of the electric shaving motor M1 in a condition where the turned on condition of shaving button switch 130 is visually recognized by the user.

After the processing at step 411, the computer determines at step 420 whether the mixing button switch 140 has been turned on or not. If the answer at step 420 is “Yes”, the computer executes processing for activating the LED 270 and the electric mixing motor M2. This activates the driving circuit 270a for light emission for lighting the LED 270 and causes the driving circuit 170b to activate the electric mixing motor M2. Thus, the sliced ice is mixed with the beverage by rotation of the electric mixing motor M2 in a condition where the turned on condition of mixing button switch 140 is visually recognized by light of the LED 270. When the stop button switch 120 is turned on in such a condition, the computer determines a “Yes” answer at step 430 and executes processing for deactivating both the electric motors M1 and M2. Thus, fine adjustment of the prepared condition of cold beverage is carried out by operation of the stop button switch 120 at a proper timing.

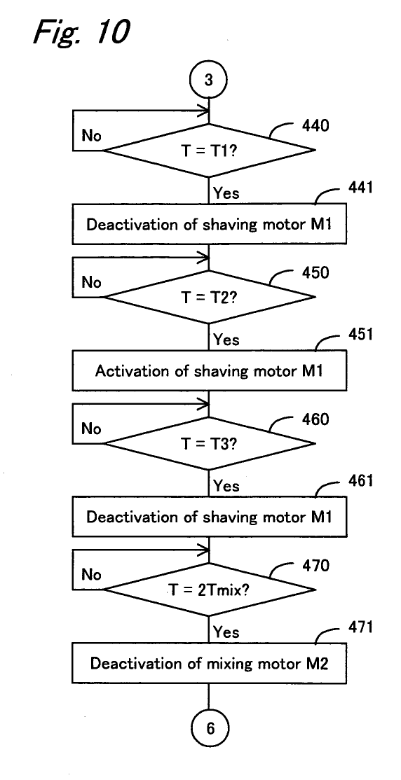

When determined two cups of cold beverage at step 380 (see FIG. 8), the computer causes the program to proceed to step 440 shown in FIG. 10. At step 440 and 441, the computer executes the same processing as that at step 390 and 391. (see FIG. 12) In this instance, the electric shaving motor M1 is activated while lapse of the time T measured by the timer is less than the predetermined time T1. Upon lapse of the predetermined time T1, the computer determines a “Yes” answer at step 400 and executes the processing for deactivating the electric shaving motor M1 at step 441. After the processing at step 441, the computer executes processing at step 450 and 451 as follows.

At step 450, the computer determines whether a predetermined time T2 has lapsed or not. While the answer at step 450 is “No”, the electric shaving motor M1 is maintained in a deactivated condition. (see FIG. 12) Upon lapse of the predetermined time T2, the computer determines a “Yes” answer at step 450 and executes at step 451 processing for activating the electric shaving motor M1. Then, the electric shaving motor M1 is driven for a predetermined time T3. During operation of the electric shaving motor M1, ice cubes A are sliced by the cutting blades 23, and the sliced ice pieces fall into the beverage container 70. The sliced ice pieces are mixed with the beverage in container 70 and stirred by the agitator during operation of the electric mixing motor M2. Upon lapse of the predetermined time T3, the computer determines a “Yes” answer at step 460 and executes processing for deactivating the electric shaving motor M1 at step 461. Upon lapse of a predetermined time 2Tmix after stopping of the electric shaving motor M1, the computer determines a “Yes” answer at step 470 and executes processing for deactivating the electric mixing motor M2 at step 471.

In the case that two cups of cold beverage are prepared as described above, the amount of sliced ice pieces and beverage becomes two times in comparison with preparation of one cup of cold beverage, and the mixing time Tmix becomes two times. Accordingly, two cups of cold beverage can be prepared in the same manner as in the preparation of one cup of cold beverage.

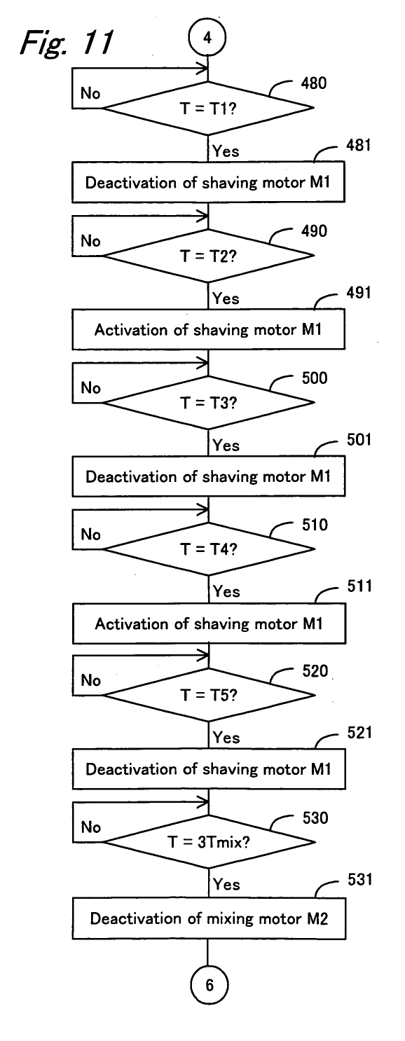

When determined three cups of cold beverage at step 380, the computer causes the program to proceed to step 480 shown in FIG. 11. In this instance, the computer executes at step 480 and 481 the same processing as that at step 440 and 441 shown in FIG. 10, executes at step 490 and 491 the same processing as that at step 450 and 451 and executes at step 500 and 501 the same processing as that at step 460 and 460a. After the processing at step 501, the computer determines whether lapse of the time T is a predetermined time T4 or not. When determined a “Yes” answer at step 510, the computer executes processing for activating the electric shaving motor M1 at step 511. (see FIG. 12) Thus, the electric shaving motor M1 is driven so that ice cubes are sliced by the cutting blades in the same manner as described above.

Subsequently, the computer determines at step 520 whether a predetermined time T5 has lapsed or not. Upon lapse of the predetermined time T5, the computer determines a “Yes” answer at step 520 and executes processing for deactivating the electric shaving motor M1 at step 521. After the processing at step 521, the computer determines whether a predetermined time 3Tmix has lapsed or not at step 530. Upon lapse of the predetermined time 3Tmix, the computer determines a “Yes” answer at step 530 and executes processing for deactivating the electric mixing motor M2 at step 531.

In the case that three cups of cold beverage are prepared as described above, the amount of sliced ice pieces and beverage becomes three times in comparison with the preparation of one cup of cold beverage, and the mixing time Tmix becomes three times. Accordingly, three cups of cold beverage can be prepared in the same manner as in the preparation of one cup of cold beverage.

In the first embodiment described above, the following useful effects are attainable. The ice cubes falling from the chute C1 are introduced into a space between the downwardly inclined conical inner surface 10a of upper hood 10 and the downwardly inclined conical upper surface 21 of cutting disk 20 and thrusted toward the cutting blades 23 under the component F1 of a centrifugal force F caused by rotation of rotary shaft 30. Thus, the ice cubes are sliced by the cutting blades 23 positioned in the radial direction across the axis of rotary shaft 30. This is effective to decrease cutting noises of the ice cubes in operation and to slice the ice cubes in a short period of time. With arrangement of the plural cutting blades about the rotary shaft 30, the cutting mechanism SM can be constructed small in size, and the ice cubes A can be sliced in a shorter period of time. In the case that the chute C1 is inserted into the inlet opening 12 formed in the cylindrical head portion of upper hood 10 to introduce the ice cubes falling from the ice storage container C toward the rotary shaft 30, ice cubes in the ice storage container C can be prevented from rotation with the rotary shaft 30 to decrease noises in operation.

As the cutting disk 20 and lower hood 40 in the cold beverage blender are mounted to the lower end outer periphery of upper hood 10 by means of common screws, the cutting blades 23 assembled with the cutting disk 20 and the rotary wing 31 can be removed downwardly in a simple manner for washing.

### Second Embodiment

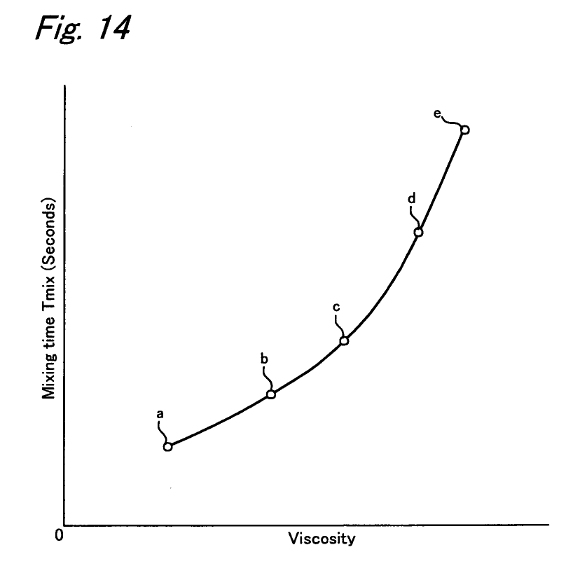

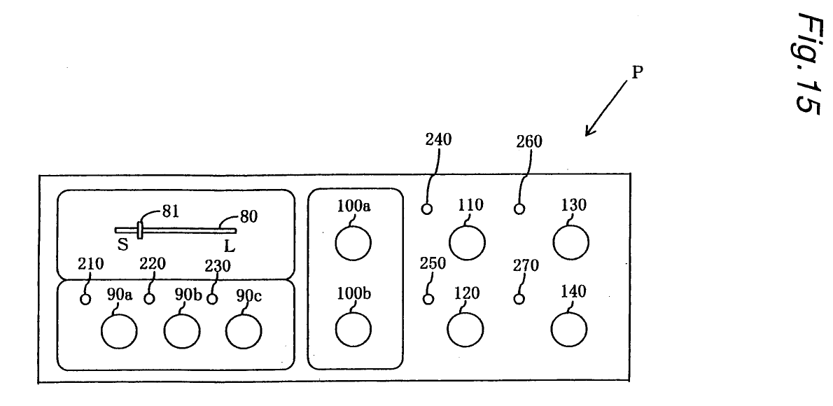

Illustrated in FIGS. 13 and 14 is a second embodiment of the present invention, wherein an analog setting device 100 such as an analog resistor is replaced with the viscosity button switches 100a, 100b in the first embodiment.(see FIG. 13) The analog setting device 100 is provided with a scale corresponding with viscosity of different beverage. In the analog setting device 100, a manual lever 101 is operated for setting each viscosity of beverage with the scale in an analog amount. In FIG. 13, the lowest viscosity of beverage is represented by the reference character L, while the highest viscosity of beverage is represent by the reference character H.

In the graph of FIG. 14, the mixing time Tmix is defined as Tmix-viscosity data in relation to each viscosity of beverage. In the graph of FIG. 14, each viscosity of grapefruit juice and margarita juice is defined by points a and b, and each viscosity of banana juice, strawberry juice and milk is defined by points c, d and e. In addition, each viscosity of other fruit juice may be defined in the graph of FIG. 14.

In this embodiment, the scale of the analog setting device 100 is utilized to set each viscosity of various beverages in an analog amount thereby to determine the mixing time at step 321 of FIG. 7. Other construction is substantially the same as that of the first embodiment.

With the second embodiment described above, each viscosity of various beverages can be analogously defined by manipulation of the analog setting device 100. Accordingly, each viscosity of various beverages can be properly set by a user, and the mixing time Tmix can be finely determined in accordance with the set value of viscosity on a basis of the Tmix-viscosity data.

### Third Embodiment

Illustrated in FIG. 15 is a third embodiment of the present invention, wherein an analog setting device 80 for setting an amount of sliced ice is replaced with the size button switches 80a˜80c in the first embodiment. In the analog setting device 80, a manual lever 81 is operated by a user for setting an analog amount corresponding with a desired amount of sliced ice. In FIG. 15, the reference character S represents a small amount of sliced ice, and the reference character L represents a large amount of sliced ice.

In the third embodiment described above, an amount of sliced ice is determined by processing at step 302 on a basis of an analog amount set by operation of the analog setting device 80. Accordingly, a desired amount of sliced ice can be finely determined by the user. Other construction and useful effects are substantially the same as those in the first embodiment.

1. An electric control apparatus of a cold beverage blender, comprising:
an ice cutting mechanism with a shaving motor operated for slicing ice cubes,
a mixing mechanism with a mixing motor operated for mixing sliced ice with beverage stored in a container to prepare an amount of cold beverage,
means for setting a desired amount of ice cubes to be sliced in the cutting mechanism,
means for setting the number of cups of cold beverage desired by a user,
shaving motor control means for controlling operation of the shaving motor in accordance with the desired amount of ice cubes and the number of cups of cold beverage, and
mixing motor control means for controlling operation of the mixing motor in accordance the desired amount of ice cubes and the number of cups of cold beverage.

2. An electric control apparatus of a cold beverage blender as set forth in claim 1, further comprising means for setting viscosity of the beverage, wherein said mixing motor control means is arranged to increase or decrease a mixing time of sliced ice in accordance with the set viscosity of the beverage so that said mixing motor is operated for the mixing time.

3. An electric control apparatus for a cold beverage blender as set forth in claim 1, wherein said means for setting a desired amount of ice cubes is in the form of plurality of switches operated by a user for setting a different amount of ice cubes, and wherein said shaving motor control means is arranged to control operation of the shaving motor in such a manner that a desired amount of ice cubes set by operation of either one of the switches is sliced in the cutting mechanism.

4. An electric control apparatus for a cold beverage blender as set forth in claim 2, wherein said means for setting a desired amount of ice cubes is in the form of plurality of switches operated by a user for setting a different amount of ice cubes and
wherein said shaving motor control means is arranged to control operation of the shaving motor in such a manner that a desired amount of ice cubes set by operation of either one of the switches is sliced in the cutting mechanism.

5. An electric control apparatus of a cold beverage blender as set forth in claim 1, wherein said means for setting a desired amount of ice cubes is in the form of an analog setting device for setting a desired amount of ice cubes in an analog amount, and wherein said shaving motor control means is arranged to control operation of the shaving motor in such a manner that a desired amount of ice cubes set by operation of the analog setting device is sliced in the cuffing mechanism.

6. An electric control apparatus of a cold beverage blender as set forth in claim 2, wherein said means for setting a desired amount of ice cubes is in the form of an analog setting device for setting a desired amount of ice cubes in an analog amount, and wherein said shaving motor control means is arranged to control operation of the shaving motor in such a manner that a desired amount of ice cubes set by operation of the analog setting device is sliced in the cutting mechanism.

7. An electric control apparatus of a cold beverage blender as set forth in claim 2, wherein said viscosity setting means is in the form of a plurality of manual switches for setting a different viscosity in accordance with viscosity of the beverage, and wherein said mixing motor control means is arranged to activate the mixing motor for a mixing time determined in accordance with the viscosity set by either one of said manual switches.

8. An electric control apparatus of a cold beverage blender as set forth in claim 4, wherein said viscosity setting means is in the form of a plurality of manual switches for setting a different viscosity in accordance with viscosity of the beverage, and wherein said mixing motor control means is arranged to activate the mixing motor for a mixing time determined in accordance with the viscosity set by either one of said manual switches.

9. An electric control apparatus of a cold beverage blender as set forth in claim 5, wherein said viscosity setting means is in the form of a plurality of manual switches for setting a different viscosity in accordance with viscosity of the beverage, and wherein said mixing motor control means is arranged to activate the mixing motor for a mixing time determined in accordance with the viscosity set by either one of said manual switches.

10. An electric control apparatus of a cold beverage blender as set forth in claim 6, wherein said viscosity setting means is in the form of a plurality of manual switches for setting a different viscosity in accordance with viscosity of the beverage, and wherein said mixing motor control means is arranged to activate the mixing motor for a mixing time determined in accordance with the viscosity set by either one of said manual switches.

11. An electric control apparatus of a cold beverage blender as set forth in claim 2, wherein said viscosity setting means is in the form of a an analog setting device for setting a viscosity in an analog amount in accordance with viscosity of the beverage, and wherein said mixing motor control means is arranged to activate the mixing motor for a mixing time determined in accordance with the analog amount of viscosity set by said analog setting device.

12. An electric control apparatus of a cold beverage blender as set forth in claim 4, wherein said viscosity setting means is in the form of an analog setting device for setting a viscosity in an analog amount in accordance with viscosity of the beverage, and wherein said mixing motor control means is arranged to activate the mixing motor for a mixing time determined in accordance with the analog amount of viscosity set by said analog setting device.

13. An electric control apparatus of a cold beverage blender as set forth in claim 5, wherein said viscosity setting means is in the form of an analog setting device for setting a viscosity in an analog amount in accordance with viscosity of the beverage, and wherein said mixing motor control means is arranged to activate the mixing motor for a mixing time determined in accordance with the analog amount of viscosity set by said analog setting device.

14. An electric control apparatus of a cold beverage blender as set forth in claim 6, wherein said viscosity setting means is in the form of an analog setting device for setting a viscosity in an analog amount in accordance with viscosity of the beverage, and wherein said mixing motor control means is arranged to activate the mixing motor for a mixing time determined in accordance with the analog amount of viscosity set by said analog setting device.

15. An electric control apparatus of a cold beverage blender as set forth in claim 3, wherein said viscosity setting means is in the form of a plurality of manual switches for setting a different viscosity in accordance with viscosity of the beverage, and wherein said mixing motor control means is arranged to activate the mixing motor for a mixing time determined in accordance with the viscosity set by either one of said manual switches.

16. An electric control apparatus of a cold beverage blender as set forth in claim 3, wherein said viscosity setting means is in the form of a an analog setting device for setting a viscosity in an analog amount in accordance with viscosity of the beverage, and wherein said mixing motor control means is arranged to activate the mixing motor for a mixing time determined in accordance with the analog amount of viscosity set by said analog setting device.
